(19) United States
(12) Patent Application Publication
(10) Pub. No.: US 2021/0373476 A1
(43) Pub. Date: Dec. 2, 2021

(54) MEDIUM EJECTION DEVICE AND IMAGE FORMING APPARATUS

(71) Applicant: Ricoh Company, Ltd., Tokyo (JP)

(72) Inventor: Hideki TOBINAGA, Kanagawa (JP)

(73) Assignee: Ricoh Company, Ltd., Tokyo (JP)

(21) Appl. No.: 17/320,475

(22) Filed: May 14, 2021

(30) Foreign Application Priority Data
May 28, 2020 (JP) 2020-093441

(51) Int. Cl. G03G 15/00; B65H 5/06; B65H 9/16

(52) U.S. Cl. CPC G03G 15/6511; B65H 9/166; B65H 5/062

(57) ABSTRACT

A medium ejection device includes a medium ejector, a medium stacker, a medium stopper, and an extended stacker. The medium ejector ejects a medium. The medium ejected from the medium ejector is stacked on a medium stacker. The medium stopper is disposed on the medium stacker and opposite the medium ejector. The extended stacker is disposed on a downstream side of the medium stopper in a medium ejection direction.

### CROSS-REFERENCE TO RELATED APPLICATION

This patent application is based on and claims priority pursuant to 35 U.S.C. § 119(a) to Japanese Patent Application No. 2020-093441, filed on May 28, 2020, in the Japan Patent Office, the entire disclosure of which is incorporated by reference herein.

### BACKGROUND

### Technical Field

Embodiments of the present disclosure generally relate to a medium ejection device and an image forming apparatus.

### Related Art

A medium ejection device included in an apparatus such an electrophotographic image forming apparatus includes a medium stacker on which a medium such as a sheet is stacked and a unit to prevent the stacked medium from falling from the medium stacker. There are various types of units to prevent the stacked medium from falling from the medium stacker.

### SUMMARY

This specification describes an improved medium ejection device that includes a medium ejector, a medium stacker, a medium stopper, and an extended stacker. The medium ejector ejects a medium. The medium ejected from the medium ejector is stacked on a medium stacker. The medium stopper is disposed on the medium stacker and opposite the medium ejector. The extended stacker is disposed on a downstream side of the medium stopper in a medium ejection direction.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIGS. 1A to 1H are views to describe a mechanism falling a sheet from an output tray and an insufficient configuration to prevent the sheet from falling from the output tray;

FIGS. 2A and 2B are schematic views illustrating a configuration of a medium ejection device according to the present embodiment including an extended stacker attached to a downstream end of an ejected sheet stopper as an end fence in a sheet ejection direction to stop the sheet that are molded as one component;

FIGS. 2C to 2E are schematic views illustrating the medium ejection device according to a second embodiment including the ejected sheet stopper inclined;

FIGS. 3A and 3B are schematic views illustrating the medium ejection device according to a third embodiment including the ejected sheet stopper having a curved shape;

FIGS. 4A to 4D are schematic views illustrating the medium ejection device according to a fourth embodiment including the ejected sheet stopper rotatable;

FIG. 5 is a schematic view illustrating the medium ejection device according to a fifth embodiment including the extended stacker having an inclined sheet ejection surface;

FIGS. 6A to 6D are schematic views illustrating the medium ejection device according to a sixth embodiment including sheet ejection roller pairs configured to stiffen the sheet; and

FIG. 6E is a schematic view illustrating the sheet ejection roller pairs of FIGS. 6A to 6D arranged in a width direction of the sheet.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Referring now to the drawings, embodiments of the present disclosure are described below. As used herein, the singular forms “a,” “an,” and “the” are intended to include the plural forms as well, unless the context clearly indicates otherwise.

Embodiments according to the present disclosure are described. A medium ejection device according to the present embodiment included in an apparatus such as an image forming apparatus has the following feature. That is, the medium ejection device includes an ejected sheet stopper fixed on an output tray and an extended stacker attached to the downstream end of the ejected sheet stopper in a sheet ejection direction that is the direction of movement of the sheet ejected from the medium ejection device, that is, a sheet conveyance direction. The ejected sheet stopper and the extended stacker are integrated as one component, that is, molded as one component. The ejected sheet stopper prevents a small sheet from falling from the output tray, and a large sheet such as an A3 size sheet or a double-letter size sheet is stacked on the extended stacker downstream from the ejected sheet stopper in the sheet ejection direction. With reference to drawings, the above feature is described in detail. Before describing the above feature, a general configuration is described.

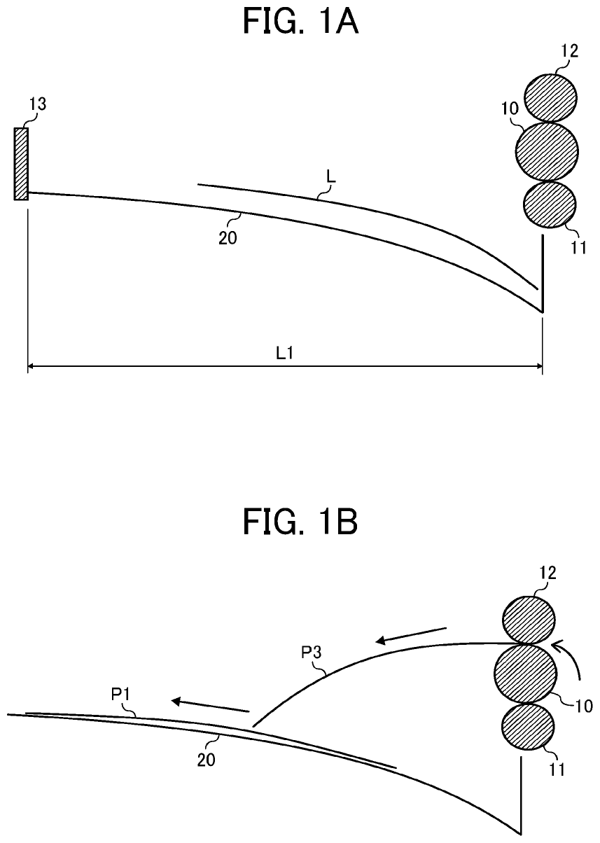

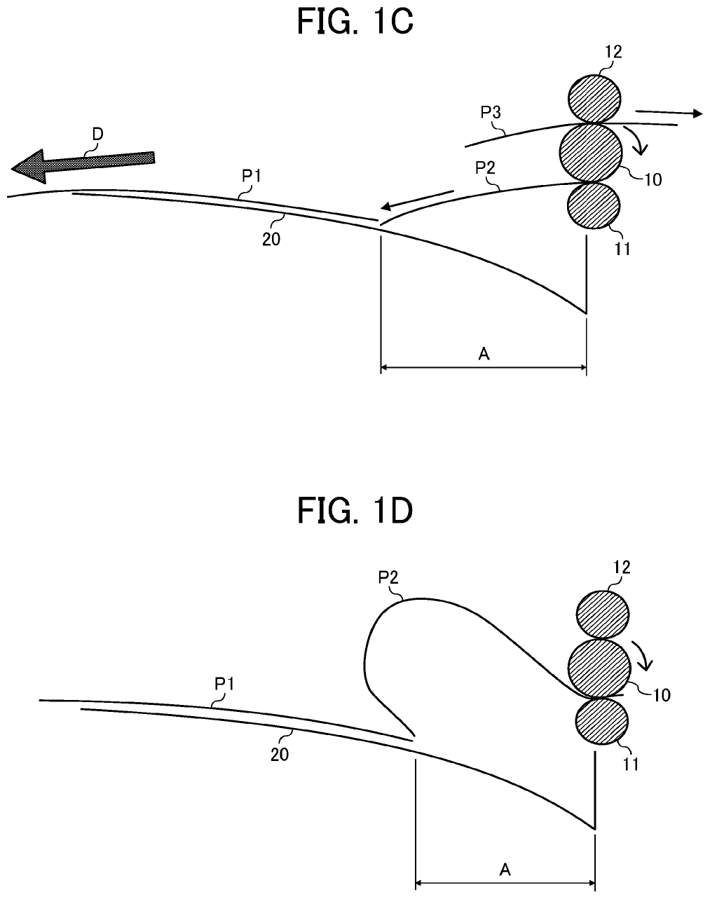

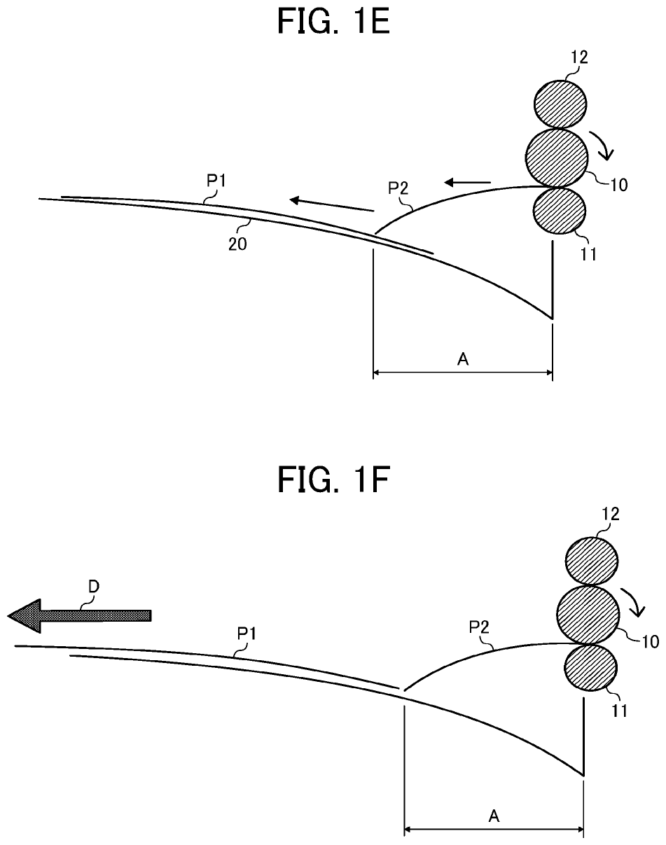

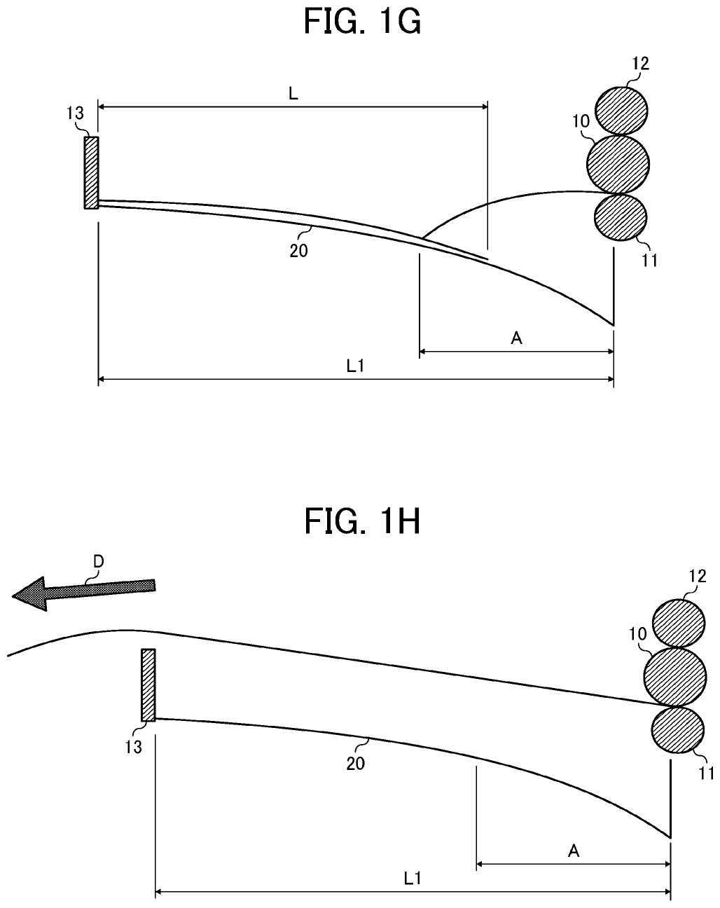

An image forming device in an electrophotographic image forming apparatus forms an image on a sheet. The sheet is conveyed and ejected to an output tray serving as an ejected sheet stacked portion. As a result, the sheet is stacked on the output tray. A sheet stacked surface of the output tray is inclined so that the sheet stacked surface becomes higher toward the downstream in the sheet ejection direction, and the most upstream point on the sheet stacked surface in the sheet ejection direction that is near a sheet ejection roller to eject the sheet is the lowest point on the sheet stacked surface. The inclined sheet stacked surface and the weight of the ejected sheet itself neatly stack the ejected sheet on sheets on the output tray and prevent the ejected sheet from jumping out and falling from the output tray. In recent years, the size of the apparatus handling the sheets such as the electrophotographic image forming apparatus is becoming smaller and smaller. To make the apparatus such as the electrophotographic image forming apparatus smaller, the inclination angle of the output tray is designed smaller, which reduces the height of the medium ejection device. The small inclination angle of the output tray affects performance of the sheet stacked surface in which the inclination of the sheet stacked surface prevents the sheet from jumping out from the output tray and may cause the sheet to jump out and fall from the output tray. To prevent the sheet from falling from the output tray 20, the ejected sheet stopper 13 serving as an end fence that is a component to stop the sheet is disposed at the most downstream portion of the output tray 20 in the sheet ejection direction as illustrated in FIG. 1A. In FIG. 1A, it is desirable that L<L1<2L, where L is a length of the side of the sheet parallel to the sheet ejection direction, and L1 is a distance along the output tray 20 from a point on the output tray 20 on which the ejected sheet stopper 13 is disposed to a point on the output tray 20 under the nip between a sheet ejection roller 10 and a driven roller 11.

However, in practice, the above configuration is insufficient. Before the description about the insufficient points of the above configuration, how the sheet falls from the output tray is described. After a preceding sheet P1 is stacked on the output tray 20 as an uppermost sheet P1, the following sheet P3 is ejected from the sheet ejection roller to the uppermost sheet P1. At this time, the front end of the following sheet P3 may push out the uppermost sheet P1. Or, when the image forming apparatus includes a reverse driven roller 12 that functions as a reverse switchback roller pair with the upper roller of an ejection roller pair as illustrated in FIG. 1B, the edge of the sheet P3 being switched back may contact the upper face of the uppermost sheet P1 and push out the uppermost sheet P1.

As illustrated in FIG. 1C, when the position of the rear end of the pushed out sheet P1 reaches a position A described later, the front end of a following sheet P2 ejected thereafter pushes out the rear end of the preceding sheet P1 in a direction D of FIG. 1C, that is, toward the downstream end of the output tray 20. As a result, the sheet P1 is pushed out and falls from the output tray 20. Even if the uppermost sheet P1 stacked on the output tray 20 is not pushed out, the front end of the following sheet P2 may be caught by the rear end of the uppermost sheet P1 stacked on the output tray 20, which may cause a curl of the following sheet P2 as illustrated in FIG. 1D. This may cause a jam or an incorrect order of ejected sheets. The above-described position A is defined as a position at which a front end of the sheet conveyed by the ejection roller pair firstly comes in contact with the output tray 20 as illustrated in FIGS. 1C and 1D, and a distance along the output tray 20 from the position A to the point on the output tray 20 under the nip between the sheet ejection roller 10 and the driven roller 11 is referred to as a distance A.

This push-out phenomenon may occur even in a single-side printing mode to form an image on one side of the sheet as illustrated in FIG. 1E. However, in the single-side printing mode, the problem that the preceding sheet P1 is pushed out and falls from the output tray 20 is less likely to occur. As illustrated in FIG. 1E, even if the following sheet P2 pushes the preceding sheet P1, the following sheet P2 is stacked on the preceding sheet P1 after the following sheet P2 pushes the preceding sheet P1. Therefore, the preceding sheet P1 is not pushed to fall from the output tray 20. However, if the rear end of the preceding sheet P1 is separated from the sheet ejection roller by the distance A as illustrated in FIG. 1F, the following sheet P2 pushes out the preceding sheet P1 from the output tray 20.

The above gives a condition of the distance L1 about the ejected sheet stopper 13, that is, L<L1<L+A, that prevents the preceding sheet P1 from falling from the output tray 20 even if the following sheet P2 ejected from the sheet ejection roller 10 or the sheet P3 ejected from the reverse driven roller 12 pushes the preceding sheet P1 (See FIG. 1G). In the above condition, L is the length of the side of the sheet parallel to the sheet ejection direction, L1 is the distance along the output tray 20 from the point on the output tray 20 on which the ejected sheet stopper 13 is disposed to the point on the output tray 20 under the nip between the sheet ejection roller 10 and the driven roller 11, and A is the distance along the output tray 20 from the position A at which the sheet conveyed by the ejection roller pair firstly comes in contact with the output tray to the point on the output tray 20 under the nip between the sheet ejection roller 10 and the driven roller 11.

Next, the insufficient point of the above-described configuration is described. The image forming apparatus uses sheets having different lengths and widths. The different lengths L of the sheets give different distances L1 in the medium ejection device based on the above condition. To set the ejected sheet stopper 13 at optimum positions corresponding to the lengths of the sheets, the image forming apparatus may include the ejected sheet stopper movable or a plurality of ejected sheet stoppers 13 corresponding to the lengths of the sheets.

In the above-described image forming apparatus, a user moves the ejected sheet stopper 13 or switches one of the plurality of ejected sheet stoppers 13 based on one of the lengths of the sheets. That is, this configuration needs the user's operation. If the user does not set the ejected sheet stopper 13 based on the length of the sheet that the user uses, the above-described configuration cannot suitably function. For example, when the image forming apparatus is designed to form the image on the A4 size (210 mm by 297 mm) sheet or the letter size (8½ inches by 11 inches) sheet and convey the sheet in the image forming apparatus so that the shorter side of the sheet is the front end in the sheet ejection direction, which is referred to as the A4 size Short Edge Feed (A4SEF) or the letter size Short Edge Feed (LTSEF), the image forming apparatus is generally designed to form the image on the legal size (8½ inches by 14 inches) sheet and convey the legal size sheet in the image forming apparatus so that the shorter side of the legal size sheet is the front end in the sheet ejection direction. The image forming apparatus is desired to be smaller. Generally, the legal-size sheet is less frequently used than the A4 size sheet and the letter size sheet. Accordingly, a width or length of the image forming apparatus to use the A4 size, letter size, and legal-size sheets is designed based on the A4SEF. This image forming apparatus generally includes an extendable tray disposed in the output tray 20 and the end fence to set at an end of the extendable tray extended. That is, when the user uses the legal-size sheet in the image forming apparatus, the user extends the extendable tray and set the end fence at the end of the extendable tray. If the user uses the legal size sheet in the image forming apparatus without setting the end fence at a position corresponding to the legal size, the legal size sheet may pass over the end fence and fall from the output tray 20 as illustrated in FIG. 1H.

In addition, when the user uses the letter size sheet (LTSEF) in the image forming apparatus after using the legal size sheet in the image forming apparatus, if the user forgets to return the position of the extendable tray to the position for the letter size, the condition of the distance L1 about the ejected sheet stopper 13 may be L1>L+A. In this case, since the extendable tray is not set at an appropriate position, the sheet falls from the output tray 20 as illustrated in FIG. 1F, or the order of ejected sheets is incorrect as illustrated in FIG. 1D.

Since the above-described configuration depends on the user operation, the above-described configuration cannot prevent a disadvantage about the sheet ejected and stacked on the output tray 20 that occurs when the user performs an operation that does not match the intention of the design (for example, using the legal size sheet although the end fence is set at the position corresponding to the letter size sheet (LTSEF) or using the letter size sheet (LTSEF) although the end fence is set at the position corresponding to the legal size sheet).

Next, features of the present embodiment to solve the disadvantage is described. The medium ejection device according to the present embodiment includes the ejected sheet stopper 13 positioned at a distance Ls+A along the output tray 20 from the point on the output tray 20 under the nip between the sheet ejection roller 10 and the driven roller 11. In the above, Ls is a length of the side of a small sheet that is frequently used, which is generally A4SEF or LTSEF, the side in parallel to the sheet ejection direction, and A is the distance along the output tray 20 from the position A at which the sheet conveyed by the ejection roller pair firstly comes in contact with the output tray to the point on the output tray 20 under the nip between the sheet ejection roller 10 and the driven roller 11. In addition, the medium ejection device includes the extended stacker attached to the downstream end of the ejected sheet stopper 13 in the sheet ejection direction. The ejected sheet stopper and the extended stacker are integrated as one component. At least a part of the ejected sheet stopper 13 is inclined. In the above-described configuration, the ejected sheet stopper 13 stops the small sheet to prevent the small sheet from falling from the output tray 20, and the large sheet can be stacked on the extended stacker downstream from the ejected sheet stopper 13 in the sheet ejection direction. As a result, the sheets are neatly stacked. The above-described configuration improves the alignment of sheets stacked on the output tray 20 in each of a plurality of sizes of sheets without moving the position of the ejected sheet stopper or using a plurality of ejected sheet stoppers.

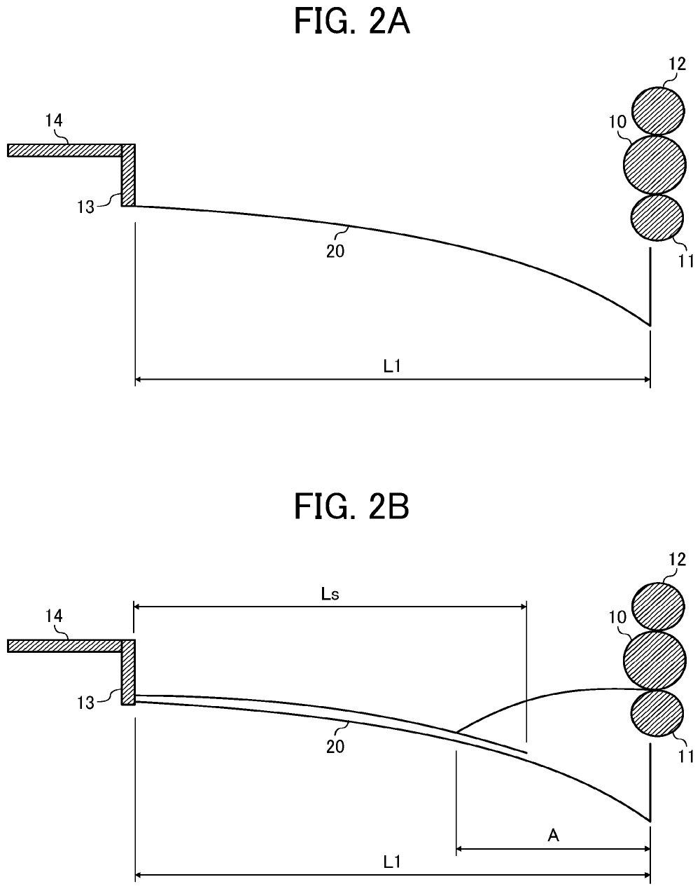

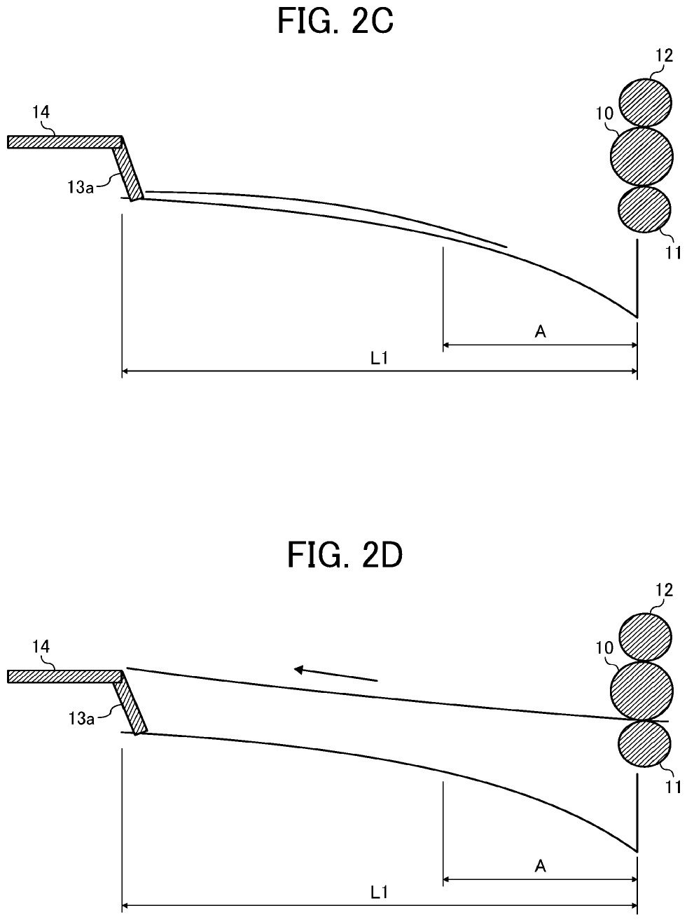

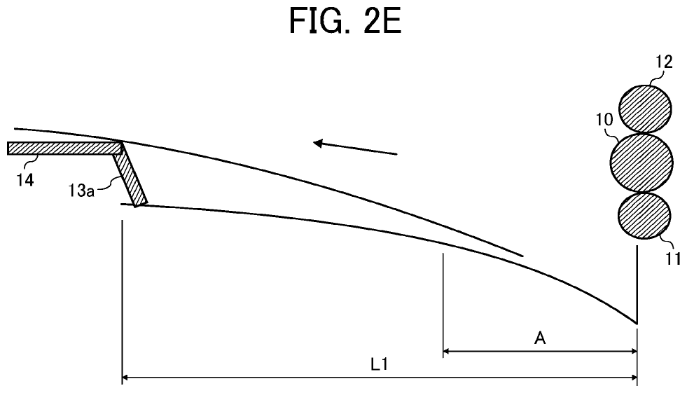

FIG. 2A is a schematic view illustrating a configuration of the medium ejection device according to the present embodiment including the extended stacker 14 attached to the downstream end of the ejected sheet stopper 13 as the end fence in the sheet ejection direction to stop the sheet. The ejected sheet stopper 13 and the extended stacker 14 are integrated as one component. As illustrated in FIG. 2A, in the medium ejection device, the ejected sheet stopper 13 as the end fence stops the small sheet to prevent the small sheet from falling from the output tray 20. On the other hand, the leading end of the large sheet is stacked on the extended stacker 14 downstream from the ejected sheet stopper 13 as the end fence to prevent the large sheet from falling from the output tray 20. As a result, the above-described configuration improves stack of sheets in each of the plurality of sizes of sheets without moving the position of the end fence or using a plurality of end fences.

In order to reliably stack the small sheets between the ejected sheet stopper 13 as the end fence and the sheet ejection roller 10, the ejected sheet stopper 13 is positioned at the distance L1 satisfying L1=<Ls+A as illustrated in FIG. 2B, where L1 is the distance along the output tray 20 from the point on the output tray 20 on which the ejected sheet stopper 13 is disposed to the point on the output tray 20 under the nip between the sheet ejection roller 10 and the driven roller 11, Ls is the length of the side of the small sheet that is frequently used, which is generally A4SEF or LTSEF, the side in parallel to the sheet ejection direction, and A is the distance along the output tray 20 from the position A at which the sheet conveyed by the ejection roller pair firstly comes in contact with the output tray 20 to the point on the output tray 20 under the nip between the sheet ejection roller 10 and the driven roller 11. When the image forming apparatus repeats printing, the distance A varies. The variation range of the distance A depends on paper types. However, the range of the distance A is within a range of 40 mm to 50 mm, that is, ±20 mm to 25 mm. Therefore, it is desirable to set the distance A in the above condition based on the minimum value of the range of the distance A.

Next, a second embodiment is described. As illustrated in FIG. 2C, a part of an ejected sheet stopper 13a as the end fence in the second embodiment is inclined. The ejected sheet stopper 13a in FIG. 2C is inclined so that the upper end of the ejected sheet stopper 13 in the above-described embodiment shifts to the downstream side in the sheet ejection direction. In this configuration, the small sheet comes in contact with a lower portion of the ejected sheet stopper 13a as the end fence because the small sheet moves along the surface of the output tray 20 after the small sheet arrives the output tray 20 as illustrated in FIG. 2C. On the other hand, the large sheet comes in contact with the upper portion of the inclined portion of the ejected sheet stopper 13a. Since the angle formed by the inclined portion and the large sheet is small, the large sheet is not caught by the ejected sheet stopper 13a and stacks on the extended stacker 14 downstream from the ejected sheet stopper 13a as illustrated in FIGS. 2D and 2E.

The above-described configuration aligns positions of the sheets stacked and improves the alignment of sheets stacked on the output tray 20 in each of the plurality of sizes of sheets without moving the position of the ejected sheet stopper or using a plurality of ejected sheet stoppers.

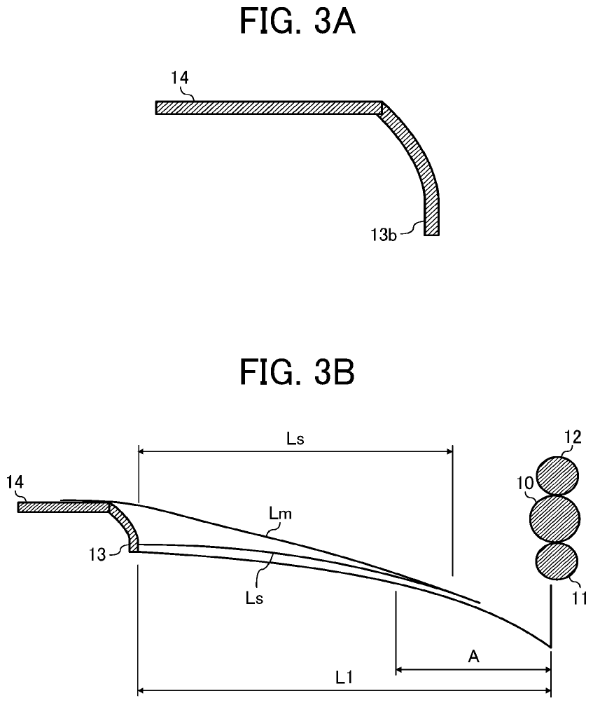

Next, the third embodiment is described. As illustrated in FIG. 3A, the ejected sheet stopper 13b as the end fence according to the third embodiment includes a lower portion that is substantially vertical and an upper portion inclined toward downstream in the sheet ejection direction, and the inclination angle of the inclined upper portion increases upward. That is, the closer to the root, the more vertical the lower portion of the ejected sheet stopper 13b as the end fence is, and the upper portion of the ejected sheet stopper 13 has a curved shape that draws an arc toward the downstream side in a sheet ejection direction. The above-described configuration further improves the effect described in the configuration of FIGS. 2C to 2E. That is, since the lower portion of the ejected sheet stopper 13b as the end fence is substantially orthogonal to the surface of the output tray 20 (that is, the surface on which the sheet is stacked), the small sheet reliably abuts on the ejected sheet stopper 13b as the end fence and stops. On the other hand, the large sheet comes in contact with the upper portion of the ejected sheet stopper 13b as the end fence. Since a contact angle formed by the upper curved portion and the large sheet is small, a resistance force applied from the ejected sheet stopper 13b to the large sheet is small, and the large sheet reaches the extended stacker 14 downstream from the ejected sheet stopper 13b as illustrated in FIG. 3B.

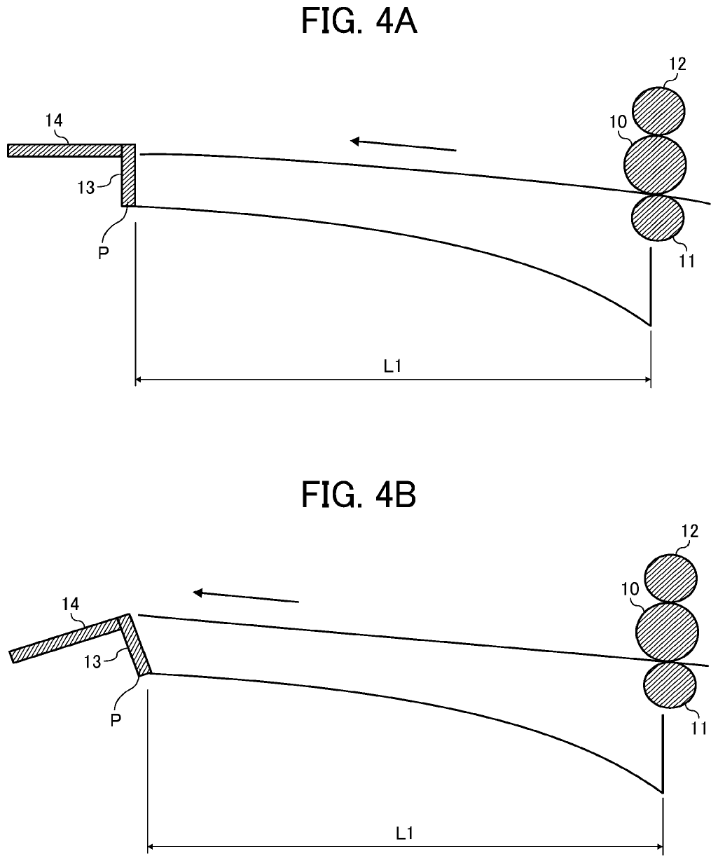

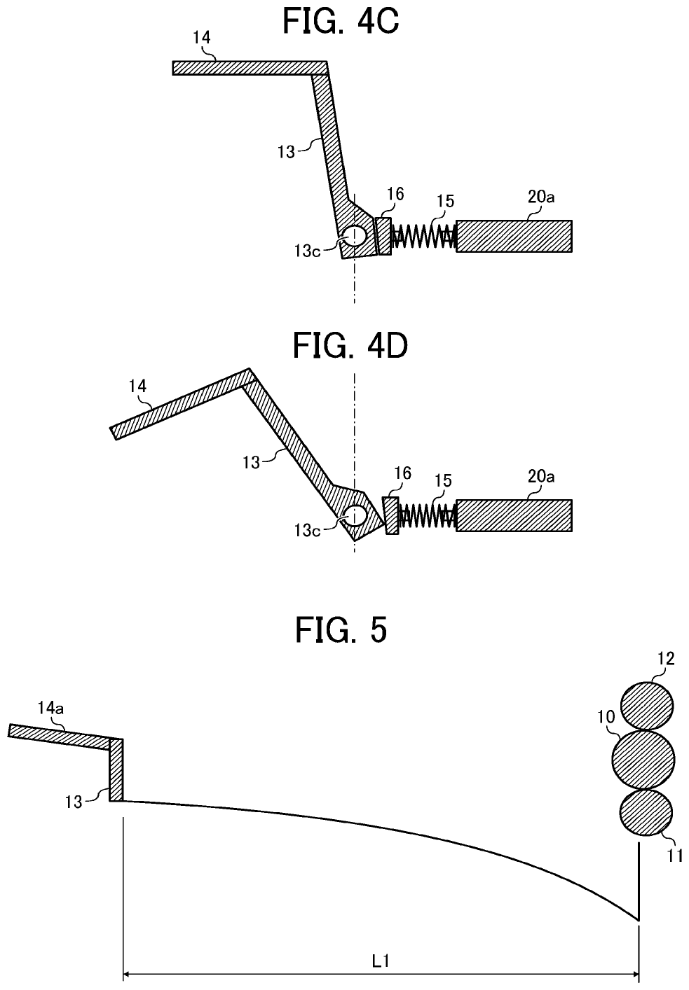

Next, a fourth embodiment is described. FIGS. 4A to 4D are schematic views illustrating the ejected sheet stopper 13 as the end fence according to the fourth embodiment in which a spring or the like applies a biasing force to the ejected sheet stopper 13. The ejected sheet stopper 13 as the end fence is rotatable about a lower portion of the ejected sheet stopper 13 as a fulcrum P and is biased clockwise in FIGS. 4A to 4D. The large sheet that reaches the ejected sheet stopper 13 as the end fence applies a force to the ejected sheet stopper 13 to pivot the ejected sheet stopper 13 as illustrated in FIG. 4B. Since the ejected sheet stopper 13 inclines toward the downstream side in the sheet ejection direction, the conveyance of the sheet is not stopped, and the large sheet is stacked on the extended stacker 14. After the front end of the large sheet passes through the ejected sheet stopper 13 as the end fence, the restoring force of the spring returns the ejected sheet stopper 13 from the inclined state as illustrated in FIG. 4B to an original state as illustrated in FIG. 4A. When the small sheet is ejected, the small sheet abuts on the lower portion of the ejected sheet stopper 13 near the fulcrum and dose not pivot the ejected sheet stopper 13, and the ejected sheet stopper 13 functions as the end fence.

FIG. 4C is a schematic view illustrating the ejected sheet stopper 13 and the extended stacker 14 in detail, which are illustrated in FIGS. 4A and 4B. The ejected sheet stopper 13 serving as the end fence is integrated with the extended stacker 14 and rotates around the fulcrum 13c disposed in the ejected sheet stopper 13 as the end fence. A compression spring 15 is set between a downstream end portion 20a of the output tray 20 in the sheet ejection direction and a pressing member 16. FIG. 4C illustrates the state of FIG. 4A, and FIG. 4D illustrates the state of FIG. 4B. As illustrated in FIG. 4B, the front end of the sheet reaches the ejected sheet stopper 13 as the end fence and applies the force to the ejected sheet stopper 13. The force generates a counterclockwise moment around the fulcrum 13c in FIGS. 4C and 4D, compressing the compression spring. At this time, a contact angle formed between the front end of the sheet and the ejected sheet stopper 13 as the end fence becomes small as illustrated in FIGS. 4B and 4D. As a result, the resistance force that is applied to the sheet conveyed also becomes small, thereby improving the conveyance performance. After the front end of the sheet passes above the ejected sheet stopper 13, the energy stored in the compression spring 15 is released and returns the ejected sheet stopper 13 as the end fence to the state illustrated in FIG. 4C.

Next, a fifth embodiment is described. As illustrated in FIG. 5, the extended stacker 14 may have an inclined shape so that a sheet ejection surface becomes higher toward the downstream side in the sheet ejection direction. FIG. 5 illustrates an example of the extended stacker 14a having the sheet ejection surface that is higher toward the downstream side in the sheet ejection direction. The configuration in FIG. 5 can reliably prevent the sheet from falling from the output tray 20 and improve stack alignment because the sheet is more likely to return in the upstream direction (the right direction in FIG. 5).

Next, a sixth embodiment is described. The medium ejection device according to the fifth embodiment has an adjustor that can adjust and fix a sheet ejection position so that the front end of the large sheet ejected from the sheet ejection position reaches a position higher than the ejected sheet stopper 13 as the end fence. A configuration of the adjustor to adjust the sheet ejection position may be a general configuration in which sliding the sheet ejection roller 10 and the driven roller 11 up and down moves the nip between the sheet ejection roller 10 and the driven roller 11 up and down. The above-described configuration can directly stack the large sheet on a receiving surface of the extended stacker 14, and the front end of the large sheet ejected does not come into contact with the ejected sheet stopper 13 as the end fence.

Next, a seventh embodiment is described. In the medium ejection device according to the seventh embodiment, a sheet ejection angle of the sheet ejected from the nip between the sheet ejection roller 10 and the driven roller 11 is set upward, and the sheet is stiffened by the sheet ejection roller pair so that the front end of the large sheet is directly stacked on the receiving surface of the extended stacker 14.

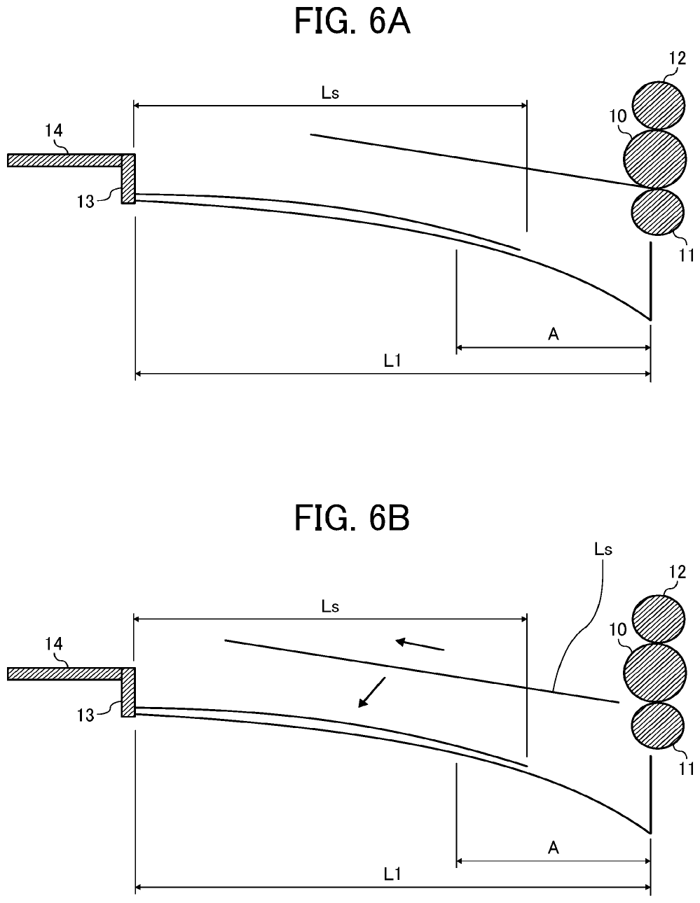

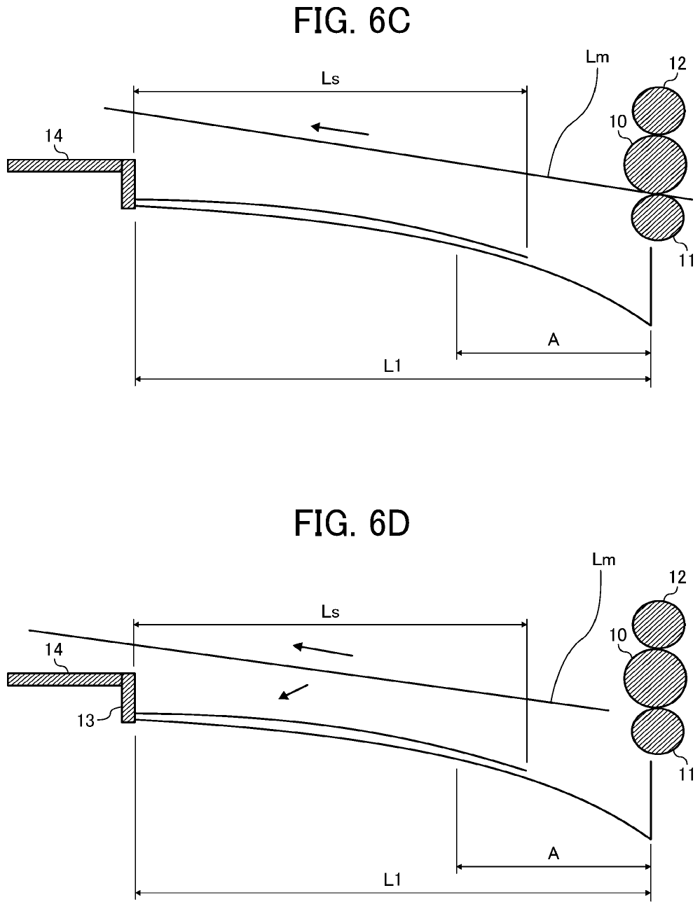

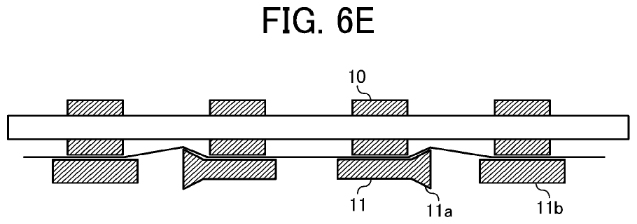

As illustrated in FIG. 6A, the small sheet having the length Ls is ejected and stiffened, but the stiffness of the small sheet is released after an end of the small sheet is ejected from the sheet ejection roller pair and before the front end of the small sheet reaches the ejected sheet stopper 13 as the end fence because the distance L1 from the ejected sheet stopper 13 as the end fence to the nip of the sheet ejection roller pair is longer than the length Ls of the small sheet. Therefore, the small sheet is dropped onto the sheet stacked surface of the output tray 20 before the front end of the small sheet reaches the ejected sheet stopper 13 as the end fence. When the front end of the small sheet reaches the ejected sheet stopper as the end fence, the small sheet contacts the lower portion of the ejected sheet stopper and is stopped by the ejected sheet stopper 13 as illustrated in FIGS. 6A and 6B.

In contrast, the rear end of the large sheet is sandwiched by the sheet ejection roller pair even when the front end of the large sheet is reaches the ejected sheet stopper 13 as the end fence, and the front end of the large sheet that is stiffened is over the ejected sheet stopper 13 as the end fence as illustrated in FIG. 6C. Therefore, the large sheet reaches the extended stacker 14 without contacting the ejected sheet stopper 13 as the end fence. After the large sheet reaches the extended stacker 14, the large sheet is released from the sheet ejection roller 10, falls, and is stacked on the extended stacker 14 as illustrated in FIG. 6D. FIG. 6E is a schematic view illustrating an example of a device that stiffen the ejected sheet. The device includes a plurality of ejection roller pairs arranged in a width direction of the sheet. The plurality of ejection roller pairs includes a pair of sheet ejection rollers 10 that are drive rollers, a pair of sheet ejection driven rollers that are driven rollers 11 and sheet ejection rollers, and flanges 11a attached on the pair of sheet ejection driven rollers. The sheet is sandwiched by the plurality of ejection roller pairs and is stiffened. However, the device is not limited to above.

The above-described embodiments relate to a medium ejection device including the medium stacker on which a medium such as the sheet ejected from a part such as an image forming section of the image forming apparatus is stacked and a unit to prevent the medium stacked on the medium stacker from falling from the medium stacker. That is, the medium ejection device in each of the present embodiments includes the extended stacker 14 attached to the downstream end of the ejected sheet stopper 13 as the end fence in a medium ejection direction that is the sheet ejection direction. The ejected sheet stopper 13 and the extended stacker 14 are integrated as one component. An apparatus handling the medium, such as the image forming apparatus includes the medium ejection device.

That is, the medium ejection device in the above-described embodiments includes a medium ejector such as the sheet ejection roller pair including the sheet ejection roller 10 and the driven roller 11 configured to eject the medium, a medium stacker such as the output tray 20 on which the medium ejected from the medium ejector is stacked, a medium stopper such as the ejected sheet stopper 13 disposed on the medium stacker and opposite the medium ejector, and an extended stacker such as the extended stacker 14 disposed on a downstream side of the medium stopper in the medium ejection direction such as the sheet ejection direction. The above-described structure can prevent the above-described disadvantage about the medium ejected and stacked on the medium stacker.

In addition, the medium stopper in the medium ejection device may have a portion inclined toward downstream in the medium ejection direction. The above-described structure can prevent the above-described disadvantage about the medium ejected and stacked on the medium stacker, such as falling the medium from the medium stacker as described above, which is affected by a type of the medium.

In addition, the medium ejection device may include the medium stopper including a lower portion orthogonal to a surface of the medium stacker to stack the medium and an upper portion inclined toward downstream in the medium ejection direction and having an inclination angle increasing upward. The above-described structure enables a small medium to contact the medium stopper as the end fence to stop the small medium. On the other hand, a large medium comes in contact with the upper portion of the medium stopper as the end fence. Since a contact angle formed by the upper portion and the large medium is small, the resistance force applied from the medium stopper to the large medium is small, and the large medium reaches the extended stacker downstream from the medium stopper.

In addition, the medium ejection device may include a biasing member such as the compression spring 15 configured to pivot the medium stopper toward upstream in the medium ejection direction about a fulcrum such as the fulcrum 13C disposed on the lower portion of the medium stopper. Additionally, the medium stopper is configured to be pivoted and inclined about the fulcrum toward the downstream side in the medium ejection direction by the medium conveyed by a conveyance force larger than a biasing force of the biasing member, and the biasing force of the biasing member returns the medium stopper from an inclined state to an original state in response to the conveyance force smaller than the biasing force. In the above-described structure, the large medium ejected temporally inclines the medium stopper, rises on the medium stopper, and is stacked on the extended stacker downstream from the medium stopper in the medium ejection direction.

In addition, the medium ejector in the medium ejection device may include an adjustor configured to adjust a front end of the medium in the medium ejection direction so as to reach a position higher than the medium stacker. For example, the adjuster is configured by the sheet ejection roller 10 and the driven roller 11 that vertically slide. The above-described adjustor can adjust the front end of the large medium ejected from the medium ejector to reach the position higher than the medium stopper such as the ejected sheet stopper 13 as the end fence. The front end of the large medium ejected does not come into contact with the medium stopper as the end fence. The large medium is directly stacked on a receiving surface of the extended stacker such as the extended stacker 14.

In addition, the medium ejector in the medium ejection device may include a device configured to stiffen the medium, such as the above-described sheet ejection roller pair including the flange 11a attached on the sheet ejection driven roller to stiffen the sheet. In the above-described structure, the front end of the large medium stiffened passes over the medium stopper as the end fence and reaches the extended stacker without contacting the medium stacker as the end fence because the rear end of the large medium having the front end reaching over the medium stacker is held by the device to stiffen the medium in the medium ejector, such as the sheet ejection roller pair described above. On the other hand, since the device to stiffen the medium releases the rear end of the small medium earlier than the large medium, the front end of the small sheet falls to the surface of the medium stacker such as the output tray 20. That is, the above-described structure can reliably guide the large sheet to the extended stacker

The embodiments of the present disclosure have been described in detail above. The above-described embodiments are examples and can be modified within the scope not departing from the gist of the present disclosure. For example, any embodiment and any modification may be combined.

Numerous additional modifications and variations are possible in light of the above teachings. It is therefore to be understood that within the scope of the appended claims, the present disclosure may be practiced otherwise than as specifically described herein. The number, position, and shape of the components of the image forming apparatus described above are not limited to those described above.

What is claimed is:

1. A medium ejection device comprising:
a medium ejector configured to eject a medium;
a medium stacker on which the medium ejected from the medium ejector is stacked;
a medium stopper disposed on the medium stacker opposite the medium ejector; and
an extended stacker disposed on a downstream side of the medium stopper in a medium ejection direction.

2. The medium ejection device according to claim 1, wherein the medium stopper and the extended stacker are molded as one component.

3. The medium ejection device according to claim 1, wherein the medium stopper has a portion inclined toward downstream in the medium ejection direction.

4. The medium ejection device according to claim 3,
wherein the medium stopper includes a lower portion orthogonal to a surface of the medium stacker, the surface being configured to stack the medium, and an upper portion inclined toward downstream in the medium ejection direction and having an inclination angle increasing upward.

5. The medium ejection device according to claim 1, further comprising
a biasing member configured to pivot the medium stopper toward upstream in the medium ejection direction about a fulcrum disposed on a lower portion of the medium stopper,
wherein the medium stopper is configured to be pivoted and inclined about the fulcrum toward downstream in the medium ejection direction by the medium conveyed by a conveyance force larger than a biasing force of the biasing member, and
wherein the biasing force of the biasing member returns the medium stopper from an inclined state to an original state in response to the conveyance force being smaller than the biasing force.

6. The medium ejection device according to claim 1,
wherein the extended stacker has an inclined ejection surface.

7. The medium ejection device according to claim 1,
wherein the medium ejector includes an adjustor configured to adjust a front end of the medium in the medium ejection direction so as to reach a position higher than the medium stopper.

8. The medium ejection device according to claim 7,
wherein the medium ejector includes a device configured to stiffen the medium.

9. An image forming apparatus comprising the medium ejection device according to claim 1.
